(19) United States
(12) Patent Application Publication
(10) Pub. No.: US 2009/0008414 A1
(43) Pub. Date: Jan. 8, 2009

(54) Sure Shot

(75) Inventor: Michael Tingsley, Frankfort, KY (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Michael Tinsley, Frankfort, KY (US)

(21) Appl. No.: 12/234,207

(22) Filed: Sep. 19, 2008

Related U.S. Application Data
(63) Continuation-in-part of application No. 11/060,792, filed on Feb. 18, 2005, now abandoned.

(51) Int. Cl. B67D 5/40; B67D 5/60

(52) U.S. Cl. 222/377; 222/382; 222/464.7

(57) ABSTRACT

Included are embodiments for dispensing an agent. At least one embodiment of a system includes a reservoir having an upper portion and a lower portion, the reservoir configured to receive an agent, the reservoir including a sump, the sump positioned at the lower portion of the reservoir, the lower portion of reservoir shaped in a conical configuration such that the reservoir narrows substantially equally on all sides to the sump, such that the agent in the reservoir is funneled into the sump. Some embodiments include a dispensing portion configured to remove the agent from the reservoir, at least a portion of the dispensing portion being positioned in the sump, the dispensing portion configured to remove the agent from the sump for dispensing. Still some embodiments include a detachable base portion removably coupled to the reservoir, the detachable portion configured to receive at least a portion of the agent from the reservoir.

### CROSS REFERENCE

The present application is a continuation-in-part of U.S. patent application Ser. No. 11/060,792, filed Feb. 18, 2005, which is hereby incorporated by reference in its entirety.

### BACKGROUND

Dispensing containers have many applications, including housecleaning, gardening, hair care, etc. Many dispensing containers include a tube that is coupled to a dispensing portion for dispensing an agent (such as liquid, cream, lotion, etc.). When the tube is inserted into the bottle, the tube may extend to a position just above a base portion of the bottle. In operation, a user may activate the dispensing portion to suction the agent from inside the bottle, through the tube, and out through the dispensing portion. When the agent in the bottle is at a low level, the tube may not be able reach all the remaining agent. Thus, it may be difficult to suction the remaining agent into the tube when the trigger is applied. Consequently, this agent may remain in the bottle and thus go unused. Similarly, cleaning aids, such as wet and/or dry wipes may have a variety of uses. Such cleaning aids can be used in personal hygiene, house cleaning, and/or other applications. In many cleaning aid dispensers however, it may be difficult to retain moisture and/or otherwise store the cleaning aid.

### SUMMARY

Included are embodiments for dispensing an agent. At least one embodiment of a system includes a reservoir having an upper portion and a lower portion, the reservoir configured to receive an agent, the reservoir including a sump, the sump positioned at the lower portion of the reservoir, the lower portion of reservoir shaped in a conical configuration such that the reservoir narrows substantially equally on all sides to the sump, such that the agent in the reservoir is funneled into the sump. Some embodiments include a dispensing portion configured to remove the agent from the reservoir, at least a portion of the dispensing portion being positioned in the sump, the dispensing portion configured to remove the agent from the sump for dispensing. Still some embodiments include a detachable base portion removably coupled to the reservoir, the detachable portion configured to receive at least a portion of the agent from the reservoir.

Other embodiments and/or advantages of this disclosure will be or may become apparent to one with skill in the art upon examination of the following drawings and detailed description. It is intended that all such additional units, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

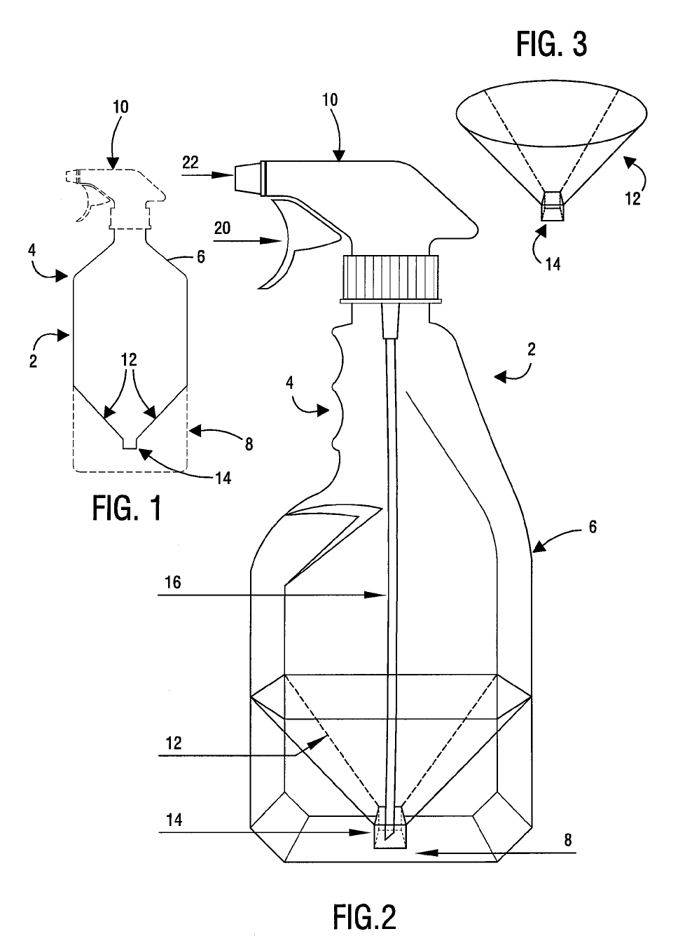

FIG. 1 illustrates an exemplary dispensing container with at least one slanted inner wall that forms a sump at a base portion of the dispensing container.

FIG. 2 illustrates another view of the exemplary dispensing container of FIG. 1, further illustrating the sump receiving a tube.

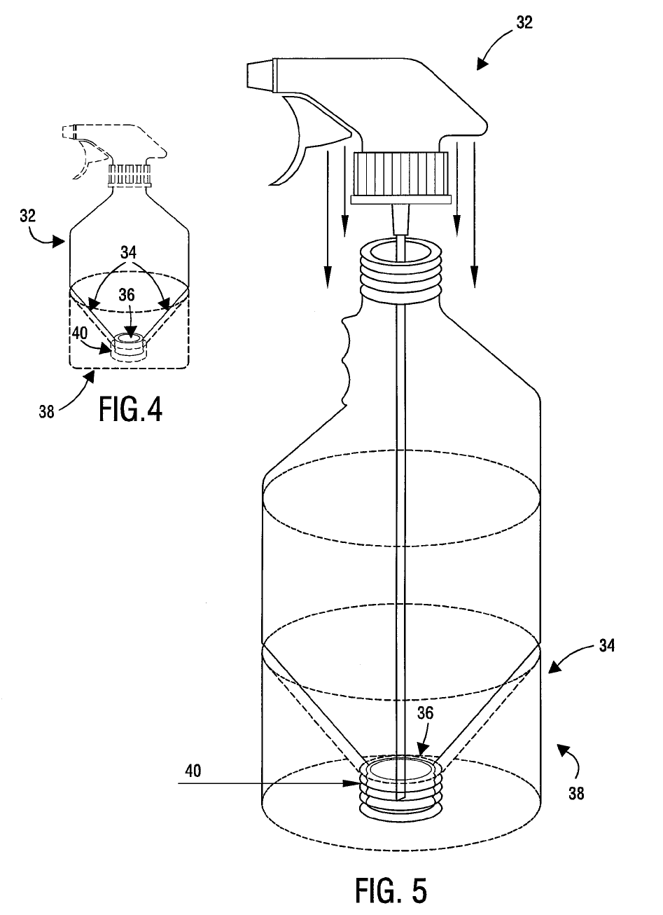

FIG. 3 illustrates the exemplary interior shape of the dispensing container, separated from an exterior portion of the dispensing container in FIG. 1.

FIG. 4 illustrates an exemplary dispensing container with a conically shaped slanted wall that forms a sump, similar to the diagram from FIG. 1.

FIG. 5 illustrates the exemplary dispensing container from FIG. 4, further illustrating a detachable base portion.

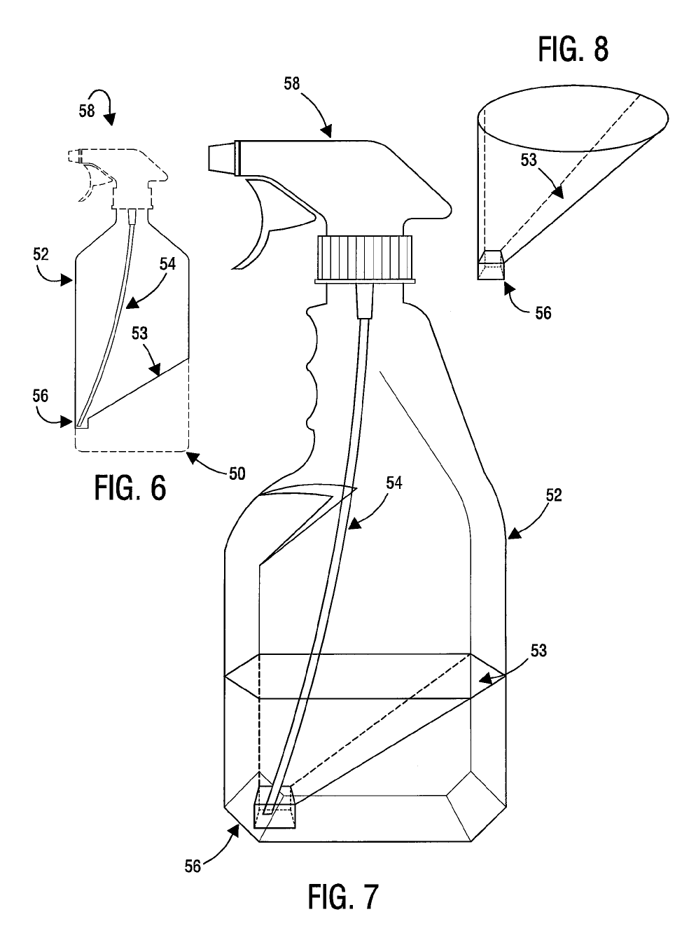

FIG. 6 illustrates an exemplary dispensing container with a sump positioned toward a front portion of the dispensing container, similar to the diagram from FIG. 4.

FIG. 7 illustrates a detailed embodiment of the exemplary dispensing container from FIG. 6.

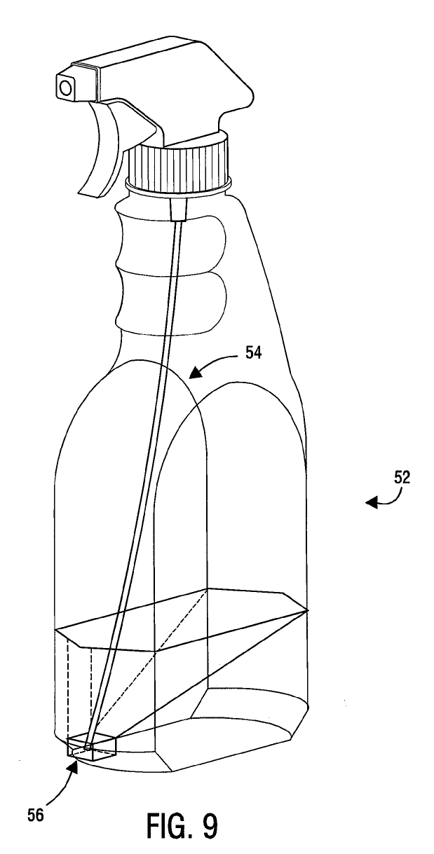

FIG. 8 illustrates a lower portion of the exemplary dispensing container from FIG. 7, separated from the dispensing container.

FIG. 9 illustrates another view of the exemplary dispensing container from FIG. 8, further illustrating a tube being positioned in a cubical sump.

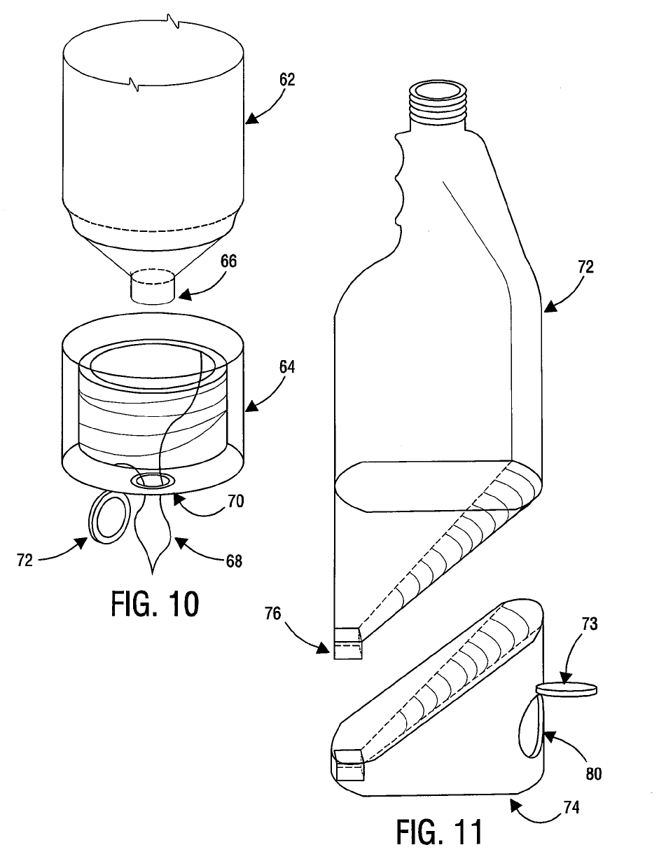

FIG. 10 illustrates a detachable base portion of an exemplary dispensing container, further illustrating a cleaning aid dispenser that may be attached and/or removed from the dispensing container, similar to the dispensing container from FIG. 5.

FIG. 11 illustrates a detachable base portion of an exemplary dispensing container, further illustrating a cleaning aid dispenser that may be attached and/or removed from the dispensing container, similar to the dispensing container from FIG. 7.

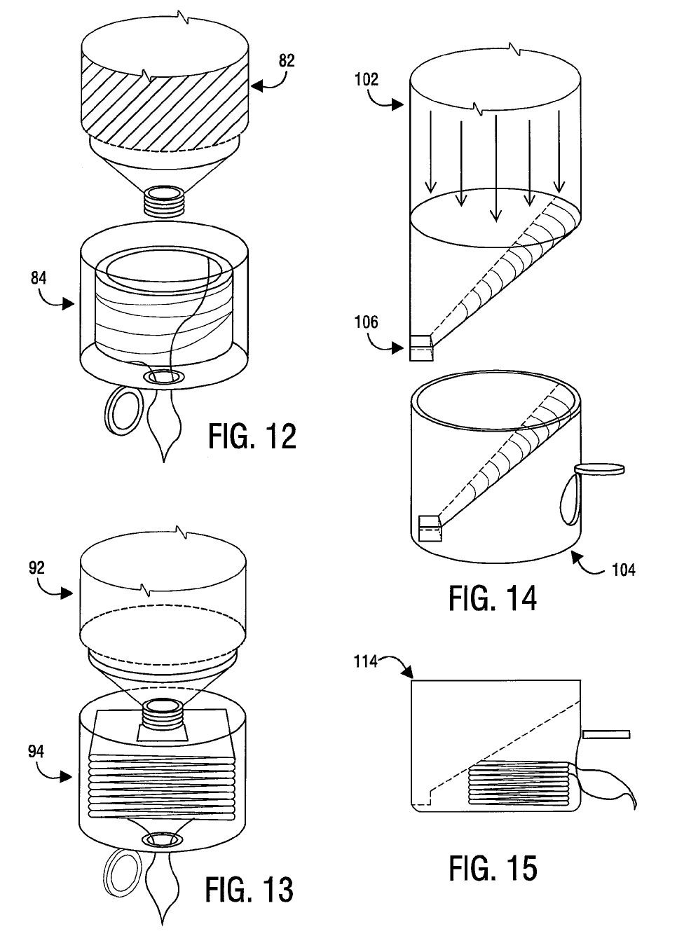

FIG. 12 illustrates a detachable base portion of an exemplary dispensing container, further illustrating a cleaning aid dispenser that is attached to the dispensing container, similar to the dispensing container from FIG. 5.

FIG. 13 illustrates another view of the detachable base portion from FIG. 12, further illustrating utilization of a rectangular cleaning aid.

FIG. 14 illustrates yet another view of a dispensing container base portion, illustrating side access to the cleaning aid, similar to the diagram from FIG. 13.

FIG. 15 illustrates yet another view of a dispensing container base portion, illustrating side access to the cleaning aid, similar to the dispensing container from FIG. 7.

### DETAILED DESCRIPTION

FIG. 1 illustrates an exemplary dispensing container 2 that includes a receptacle portion 4 and a dispensing portion 10; the receptacle portion including at least one slanted inner wall 12 that forms a sump 14. As illustrated in the nonlimiting example of FIG. 1, the receptacle portion 4 may include a top portion 6 and a base portion 8. The base portion 8 (indicated with dashed lines) may be removable; however this is not a requirement. Similarly, the dispensing portion 10 may also be removable, depending on the particular configuration.

FIG. 2 illustrates another view of the exemplary dispensing container 2 from FIG. 1, further illustrating the sump 14 that may receive a tube 16 from the dispensing portion 10. As illustrated in the nonlimiting example of FIG. 2, the dispensing portion 10 of the dispensing container 2 may include (or be coupled to) a tube 16 for suctioning the agent from the receptacle portion 4 of the dispensing container 2. The dispensing portion 10 may be removably coupled to the receptacle portion 4 via screw top and/or other securing mechanism. In operation, the tube 16 may be positioned in the sump 14, such that the agent that is in the receptacle portion 4 may be, upon activation of a sprayer trigger 20, suctioned from the sump 14, through the tube 16 and out through a nozzle 22.

Additionally, as also illustrated in FIG. 2, the slanted inner wall 12 may be shaped in a conical shape, however, this is not a requirement. More specifically, in at least one exemplary embodiment, the slanted inner wall 12 may be shaped in a pyramidal shape with the sump 14 at the pinnacle of the pyramid. Other configurations are also contemplated.

FIG. 3 illustrates the exemplary slanted interior wall 12 of the dispensing container, separated from an exterior portion of the dispensing container in FIG. 1. More specifically, FIG. 3 illustrates that any of a plurality of shapes may be utilized for the slanted interior wall 12 of the dispensing container 2. Further, depending on the particular embodiment, the slanted interior wall 12 and/or the sump 14 may be removable for replacement with a different size and/or shape component.

FIG. 4 illustrates an exemplary dispensing container 32 with a conically shaped slanted wall 34 that forms a sump 36, similar to the diagram from FIG. 1. As illustrated in the nonlimiting example of FIG. 4, the conically shaped slanted wall 34 may be configured to direct the agent to an interior portion of a sump 36. Additionally, an exterior portion of the sump 36 may be configured to receive a detachable base portion 38 at a matching connector 40. The matching connector 40 may be configured such that connection with the exterior portion of the sump 36 is removably secured.

FIG. 5 illustrates the exemplary dispensing container 32 from FIG. 4, further illustrating the detachable base portion 38. As illustrated in the nonlimiting example of FIG. 5 and discussed above with regard to FIG. 4, the base portion 38 may be grooved 40 such that the exterior portion of the sump 36 (which may be similarly grooved) can receive and secure the base portion 38 by screwing the base portion 38 onto the exterior portion of the sump 36.

One should note that, while the exemplary embodiment of FIG. 5 illustrates coupling the sump 36 and base portion 38, by rotating complementary grooved surfaces (similar to a screw-top), this is a nonlimiting example. More specifically, in some embodiments, the sump 36 and base portion 38 may clip together, glue together, utilize one or more separate screws and/or bolts, and/or otherwise removably connect. Similarly, while FIG. 5 illustrates a configuration where the sump 36 and base portion 38 are grooved in a certain manner, other grooving configurations may be utilized. Further, while a cylindrical sump is utilized with the screw-top configuration, a rectangular sump and/or other configuration may be utilized with the screw-top configuration.

FIG. 6 illustrates an exemplary dispensing container 52 with a sump 56 positioned toward a front portion of the dispensing container 52 and a nozzle 58 positioned at an upper portion of the dispensing container 52, similar to the diagram from FIG. 4. As illustrated in the nonlimiting example of FIG. 6, the sump 56 may be positioned at the front portion of the dispensing container 52, and the dispensing container 52 may have a slanted interior wall 53 towards the sump 56. In operation, a tube 54 may be positioned in the sump 56 such that the agent in the dispensing container 52 may be easily suctioned, despite the amount of the agent in the dispensing container 52. Further, by placing the sump 56 toward the front of the dispensing container 52, the agent collection may be further facilitated when the nozzle 58 is pointed in a downward direction. Similarly, some embodiments may be configured with the sump 56 located at a back portion of the dispensing container 52, such that the agent may more easily collect in the sump 56 when the nozzle 58 is pointed in an upward direction. Additionally, as illustrated with dashed lines, the nozzle 58 and base portion 50 may be removable, depending on the particular embodiment.

FIG. 7 illustrates a detailed embodiment of the exemplary dispensing container 52 from FIG. 6. As illustrated in the nonlimiting example of FIG. 7, the dispensing container may include a nozzle portion 58 and a slanted wall 53 that slants from back to front to a sump 56. Tube 54 may be inserted in to the sump 56, which may be embodied in a rectangular configuration, and/or other regular or irregular shape configuration.

FIG. 8 illustrates a lower portion of the exemplary dispensing container from FIG. 7, separated from the dispensing container. More specifically, FIG. 8 illustrates that any of a plurality of shapes may be utilized for the slanted interior wall 53 of the dispensing container 52 (FIG. 7). Further, depending on the particular embodiment, the slanted interior wall 53 and/or the sump 56 may be removable for replacement with a different size and/or shape component.

FIG. 9 illustrates another view of the exemplary dispensing container 52 from FIG. 8, further illustrating a tube 54 being positioned in a rectangular sump 56. As illustrated in the nonlimiting example of FIG. 9, the tube 54 may be placed in a rectangular sump 56; however, other shapes (e.g., conical, pyramidal, etc.) may be utilized. Additionally, in at least one exemplary embodiment, the sump 56 may be shaped to securely receive the tube 54 (or vice versa) based on size and/or shape. Similarly, an end portion of the tube may be shaped to maximize suction, based on the shape of the sump 56.

FIG. 10 illustrates a base portion of an exemplary dispensing container 62, further illustrating a cleaning aid dispenser 64 that may be attached and/or removed from the dispensing container 62, similar to the dispensing container 32 from FIG. 5. As illustrated in the nonlimiting example of FIG. 10, a base portion of a dispensing container 62 may be coupled to the dispensing container 62 at a sump 66. In this nonlimiting example, the sump 66 of the dispensing container 62 may be shaped to fit inside the cleaning aid dispenser 64 and removably attach to the cleaning aid dispenser 64. Additionally, the sump 66 may be configured to not only provide a reservoir for a tube to suction agent for spray, but may also include an aperture and/or other mechanism for providing the agent to a cleaning aid 68 in the cleaning aid dispenser 64. The passing of the agent may be via a drip mechanism, a spray mechanism, and/or or other mechanism.

Additionally, in at least one embodiment, the dispensing container 62 and/or cleaning aid dispenser 64 may include a user configurable switch for permitting and/or preventing the agent to pass to the cleaning aid dispenser 64. While it may be desirable for some cleaning aids to remain moist with the agent, it may be desirable for some cleaning aids to remain dry. Similarly, in some embodiments the user configurable switch may provide the ability to determine flow from dispensing container 62 to the cleaning aid dispenser 64.

Similarly, in at least one embodiment, the cleaning aid dispenser 64 may be configured with a reservoir for storing a second agent. The second agent may be different than the first agent; however this is not a requirement. In the exemplary embodiments where the second agent is different than the first agent, the first and second agents may be configured to chemically react with each other and/or otherwise be configured such that separation prior to application is desired. Regardless, the reservoir for the second agent may be configured for dispensing the second agent into/onto the cleaning aid via a drip mechanism, spray mechanism and/or other mechanism.

As a nonlimiting example, the sump 66 may be configured with a drip mechanism, a spray mechanism, and/or other mechanism for supplying the cleaning aid 68 with the agent for utilization with the second agent and/or the first agent. Additionally, the cleaning aid dispenser 64 may include an aperture 70 on a base portion of the cleaning aid dispenser 64 to provide access to the cleaning aid 68. The cleaning aid dispenser 64 may also include a cap 72 to prevent leakage and/or evaporation of the agent in the cleaning aid dispenser 64.

FIG. 11 illustrates a base portion of an exemplary dispensing container 72, further illustrating a cleaning aid dispenser 74 that may be attached and/or removed from the dispensing container 72, similar to the dispensing container 52 from FIG. 7. As illustrated in the nonlimiting example of FIG. 11, the dispensing container 72 may be shaped to be coupled with the cleaning aid dispenser 74. However, in FIG. 11, the dispensing container 72 includes a sump 76 that is positioned at a front portion and/or a back portion of the dispensing container 72. Accordingly, the cleaning aid dispenser 74 may be shaped to receive and removably secure the dispensing container 72. The securing of the cleaning aid dispenser 74 and the dispensing container 72 may be via a clip, adhesive, and/or other mechanism for removably securing the cleaning aid dispenser 74 and the dispensing container 72.

Additionally, as discussed with regard to the nonlimiting example of FIG. 11, the sump 76 may be configured with an aperture and/or other mechanism for facilitating disbursement of the agent from the dispensing container 72 into the cleaning aid dispenser 74. While the sump 76 may be utilized for dispensing agent from the dispensing container 72 to the cleaning aid dispenser 74, dispensing of agent to the cleaning aid dispenser 74 may be facilitated from a different point on the dispensing container 72. Additionally, depending on the particular embodiment, the cleaning aid dispenser 74 may include a side mounted aperture for providing access to a cleaning aid 78 stored within. The side mounted aperture may also be coupled with a cap 80 for preventing leakage and/or evaporation of the agent in the cleaning aid dispenser 74.

FIG. 12 illustrates a base portion of an exemplary dispensing container 82, further illustrating a cleaning aid dispenser 84 that is attached to the dispensing container 82, similar to the dispensing container 32 from FIG. 5. As illustrated in the nonlimiting example of FIG. 12, the cleaning aid dispenser 84 may be configured to couple with the dispensing container 82, as described above. Additionally, while the embodiments above are configured with a removably coupable cleaning aid dispenser, the cleaning aid dispenser 84 of FIG. 12 may be permanently built into the dispensing container 82. Additionally, as also illustrated in FIG. 12, the dispensing container 82 may or may not be configured for dispensing the agent from the receptacle portion into the cleaning aid dispenser 84. Additionally, as illustrated in FIG. 12, the cleaning aid dispenser 84 may be configured to dispense a roll of cleaning aid. Additionally, some embodiments may be configured such that the roll of cleaning aid may be replaced, while some embodiments may be configured to not provide for such replacement.

FIG. 13 illustrates another exemplary embodiment of a dispensing container 92, similar to the dispensing container 82 from FIG. 12, further illustrating utilization of a rectangular cleaning aid. More specifically, as illustrated in the nonlimiting example of FIG. 13, the dispensing container 92 can be coupled to a cleaning aid dispenser 94 (removably and/or non-removably). Additionally, while the exemplary embodiment of FIG. 12 includes a roll of cleaning aid, the cleaning aid dispenser 94 in FIG. 13 is configured to dispense a stack of cleaning aid. Further, while the dispensing containers 82 and 92 may be separate dispensing containers that are configured exclusively for either a roll-type cleaning aid dispenser or a stack-type cleaning aid dispenser, some embodiments may be configured such that the dispensing container 82, 92 can couple with a roll-type cleaning aid dispenser, a stack-type cleaning aid dispenser, and/or other type of cleaning aid dispenser.

FIG. 14 illustrates yet another view of a dispensing container 102 and cleaning aid dispenser 104, illustrating side access to a cleaning aid, similar to the diagram from FIG. 13. As illustrated in the nonlimiting example of FIG. 14, the dispensing container 102 may be configured such that the sump 106 is positioned on a front and/or back side of the dispensing container 102. Additionally, as illustrated in the nonlimiting example of FIG. 14, the cleaning aid dispenser 104 may be configured to store and/or dispense a roll-type and/or stack-type cleaning aid.

FIG. 15 illustrates yet another view of a cleaning aid dispenser 114, similar to the cleaning aid dispenser 104 from FIG. 14. As illustrated in the nonlimiting example of FIG. 15, the cleaning aid dispenser 114 may be configured to couple (removably or non-removably) with a dispensing container constructed with a sump on a front portion and/or a back portion. However, while the exemplary embodiment of FIG. 14 includes a cleaning aid dispenser that dispenses a roll-type cleaning aid, the embodiment of FIG. 15 illustrates a cleaning aid dispenser 114 that is configured to dispense a stack-type cleaning aid.

One should also note that conditional language, such as, among others, “scan,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A system for dispensing an agent, comprising:
a reservoir having an upper portion and a lower portion, the reservoir configured to receive an agent, the reservoir including a sump, the sump positioned at the lower portion of the reservoir, an interior portion of the lower portion of reservoir being shaped in a conical configuration such that the reservoir narrows substantially equally on all sides to the sump, such that the agent in the reservoir is funneled into the sump;
a dispensing portion configured to remove the agent from the reservoir, at least a portion of the dispensing portion being positioned in the sump, the dispensing portion configured to remove the agent from the sump for dispensing; and
a detachable base portion removably coupled to the reservoir, the detachable base portion configured to receive at least a portion of the agent from the reservoir.

2. The system of claim 1, wherein an exterior portion of the sump includes a screwing mechanism, such that the sump is configured to receive the detachable base portion in a screw configuration.

3. The system of claim 1, wherein the dispensing portion includes a spraying portion configured to remove the agent from the sump and dispense the agent in a mist form.

4. The system of claim 1, wherein the dispensing portion is configured to dispense lotion from the sump.

5. A system configured for dispensing an agent, comprising:
a reservoir having an upper portion and a lower portion, the reservoir configured to receive a first agent, the reservoir including a sump, the sump positioned at the lower portion of the reservoir, such that the first agent in the reservoir is channeled into the sump;
a dispensing portion configured to remove the first agent from the reservoir, the dispensing portion being positioned in the sump, the dispensing portion configured to remove the first agent from the sump for dispensing; and
a detachable base portion removably coupled to the reservoir, the detachable base portion including a cleaning aid dispenser configured to store at least one cleaning aid, the cleaning aid dispenser configured to receive at least a portion of the agent from the reservoir for application to the at least one cleaning aid.

6. The system of claim 5, wherein the lower portion of the reservoir narrows in a conical configuration substantially equally on all sides and the sump is positioned central to the conical configuration.

7. The system of claim 5, wherein the reservoir includes a first side and a second side and wherein the sump is positioned at the first side.

8. The system of claim 5, wherein the dispensing portion includes a spraying portion configured to remove the first agent from the sump and dispense the first agent in a mist form.

9. The system of claim 5, wherein the dispensing portion is configured to dispense lotion from the sump.

10. The system of claim 5, wherein the cleaning aid dispenser is configured to receive at least a portion of the first agent for application on the at least one cleaning aid.

12. The system of claim 5, wherein the cleaning aid dispenser is configured to store a second agent for application to the at least one cleaning aid, the second agent being different than the first agent.

13. The system of claim 5, wherein the at least one cleaning aid includes a roll of cleaning aid dispensed from a lateral side of the cleaning aid dispenser.

14. The system of claim 5, wherein the at least one cleaning aid includes a stack of cleaning aid dispensed from a base portion of the cleaning aid dispenser

15. A system, comprising:
a reservoir having an upper portion and a lower portion, the reservoir configured to receive an agent, the reservoir including a sump positioned at the lower portion of the reservoir, such that the agent in the reservoir is channeled into the sump;
a dispensing portion configured to remove the agent from the reservoir, the dispensing portion being positioned in the sump, the dispensing portion configured to remove the agent from the sump for dispensing; and
a detachable base portion configured to removably attach to the reservoir, the detachable base portion including a cleaning aid dispenser configured to receive at least a portion of the agent from the reservoir, wherein the system includes a user selectable switch for determining whether to allow agent to pass from the reservoir to the cleaning aid dispenser.

16. The system of claim 15, wherein the system includes at least one of the following: a dispensing container and a lotion dispenser.

17. The system of claim 15, wherein an exterior portion of the sump includes a screwing mechanism, such that the sump is configured to receive the detachable base portion in a screw configuration.

18. The system of claim 15, wherein the dispensing portion includes a spraying portion configured to remove the agent from the sump and dispense the agent in a mist form.

19. The system of claim 15, wherein the dispensing portion is configured to dispense the agent from the sump as a stream of fluid.
